(19) United States
(12) Patent Application Publication
(10) Pub. No.: US 2006/0011460 A1
(43) Pub. Date: Jan. 19, 2006

(54) Switch structure

(76) Inventor: Yung-Ching Hung, Yung Kang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/891,087

(22) Filed: Jul. 15, 2004

(51) Int. Cl. H01H 9/00

(52) U.S. Cl. 200/315

(57) ABSTRACT

A switch includes a switch main body for use together with alternating current power source, and a circuit board; the main body includes a housing, a control member pivoted to one end of the housing, and several terminals secured on the other end of the housing; the control has a holding room therein, and a through hole communicating with the holding room; the circuit board is secured in the holding room of the control, and electrically connected to the terminals of the switch main body, and has a light emitting diode, which is held in the through hole of the control and used for helping people see the switch in the dark, and which is connected with a resistor with large resistance.

### BACKGROUND OF THE INVENTION

1. Field of the Invention

The present invention relates to a switch, more particularly one, which includes an LED used as the light source for helping people find the switch in the dark instead of a neon lamp; because a large variety of light emitting diodes are available whose emitted lights are different colors and have different brightnesses, a suitable LED is selected in respect of the color and brightness of emitted light according to the purpose of the switch.

2. Brief Description of the Prior Art

Switches of the type are available that are equipped with lamps used for helping people see the switches in the dark. Conventionally, neon lamps are used in switches to serve such purpose.

However, neon lamps are prone to produce consecutive flashes under unstable electric voltage of power. And, there is no a large variety of neon lamps available that can produce lights of different colors and different brightnesses. Therefore, neon lamps are not convenient to use, and switches that are to serve different purposes can't be equipped with respective suitable neon lamps.

### SUMMARY

It is a main object of the present invention to provide an improvement on a switch to overcome the above disadvantages.

The switch of the present invention includes switch includes a switch main body, and a circuit board. The main body includes a housing, a control pivoted to one end of the housing, and several terminals secured on the other end of the housing. The control has a holding room, and a through hole communicating with the holding room. The circuit board is secured in the holding room of the control, and electrically connected to the terminals, and has a light emitting diode, which is used for helping people see the switch in the dark, and which is held in the through hole of the control.

Because a large variety of light emitting diodes are available whose emitted lights are different colors and have different brightnesses, switches of the present structure, which are used for serving different purposes, can be equipped with respective suitable light emitting diodes.

### BRIEF DESCRIPTION OF THE DRAWINGS

The present invention will be better understood by referring to the accompanying drawings, wherein:

FIG. 1 is a vertical section of the switch of the present invention switched to the open position, and

FIG. 2 is a vertical section of the switch of the present invention switched to the closed position.

### DETAILED DESCRIPTION OF THE PREFERRED EMBODIMENTS

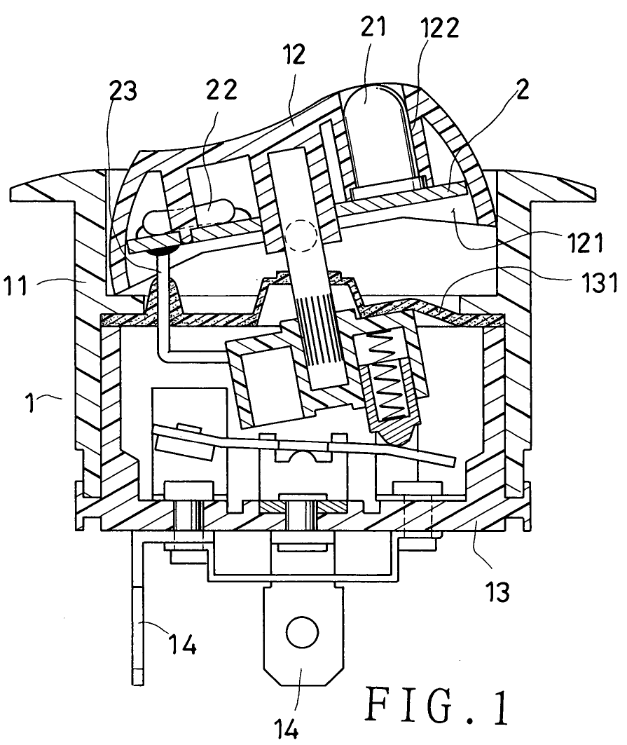

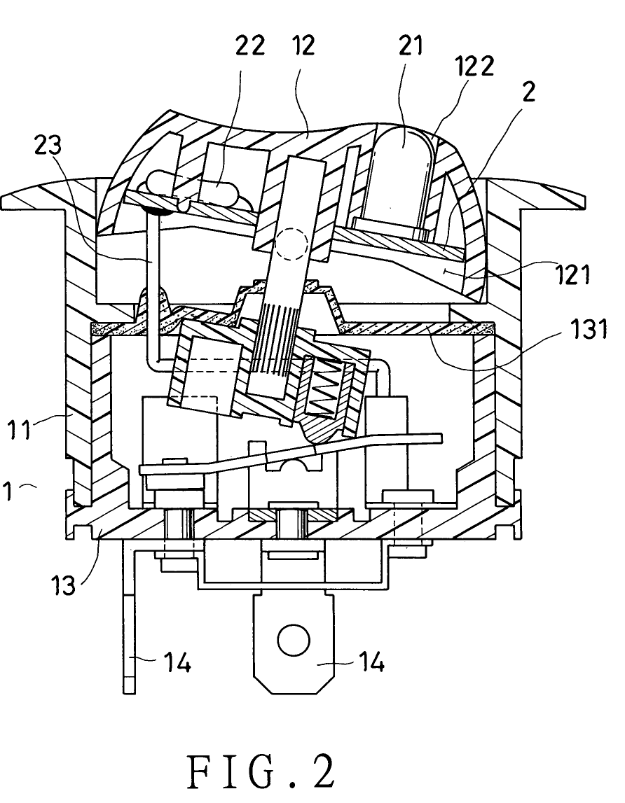

Referring to FIGS. 1 and 2, a preferred embodiment of a switch of the present invention includes a switch main body 1, and a circuit board 2.

The switch main body 1 is used together with alternating current power source, and includes first and second housing parts 11 and 13, a control member 12, and several terminals 14 secured to a lower portion of the second housing part 13. The first housing part 11 is connected with the second housing part 13 at a lower portion thereof. And, a waterproof pad 131 is positioned between the first and the second housing parts 11 and 13 for preventing leakage. The control member 12 is pivoted on an upper portion of the first housing part 11 such that the switch main body 1 can be switched from a closed position to an open position, and vice versa by means of the control member 12; when the switch main body 1 is in the closed position, power can be supplied through the terminals 14. Furthermore, the control member 12 has a holding room 121 therein, and a through hole 122 communicating with the holding room 121.

The circuit board 2 has a light emitting diode (LED) 21 fitted thereon, and a resistor 22 with large resistance is connected with the light emitting diode 21. The circuit board 2 is secured in the holding room 121 of the control member 12 with the light emitting diode 21 being held in the through hole 122. Furthermore, the circuit board 2 is electrically connected to the terminals 14 of the switch main body 1 by means of a wire 23, which is passed through the second housing part 13 before it is connected to the terminals 14.

Therefore, the light emitting diode 21 can emit light, and the light can travel outside through the through hole 122 of the control member 12 to help people see the present switch in the dark. Because a large variety of light emitting diodes are available whose emitted lights are different colors and have different brightnesses, switches of the present structure, which are used for serving different purposes, can be equipped with respective suitable light emitting diodes.

From the above description, it can be understood that the switch of the present invention has the following advantages:
1. It can be equipped with a suitable light emitting diode according to the purpose thereof.
2. Light emitted from light emitting diodes won't become consecutive flashes under unstable electric voltage of power therefore the present switch is better as compared with the conventional switch, which is equipped with neon lamps, in respect of emitted light.
3. The present switch has the waterproof pad therefore leakage is prevented.

What is claimed is:

1. A switch, comprising
a switch main body for use together with alternating current power source; the switch main body including a housing, and a control member pivoted to one end of the housing; the control member having a holding room therein, and a through hole communicating with the holding room; the switch main body having a plurality of terminals secured on other end of the housing; and
a circuit board secured in the holding room of the control member; the circuit board having a light emitting diode fitted thereon and used for helping people see the switch in the dark; the light emitting diode being connected with a resistor with large resistance; the light emitting diode being held in the through hole of the control member; the circuit board being electrically connected to the terminals of the switch main body by means of a wire.
